(19) United States
(12) Patent Application Publication
(10) Pub. No.: US 2025/0314744 A1
(43) Pub. Date: Oct. 9, 2025

(54) MULTI-MODE OPTICAL SENSING FOR OBJECT RECOGNITION

(71) Applicant: GREEN2PASS LTD., Ashkelon (IL)

(72) Inventors: Reuven NANIKASHVILI, Ashdod (IL); Mordehai BAR-TAL, Ashdod (IL)

(21) Appl. No.: 18/867,633

(22) PCT Filed: May 22, 2023
(86) PCT No.: PCT/IL2023/050524

§ 371 Date: Nov. 20, 2024

(30) Foreign Application Priority Data
May 22, 2022 (IL) 293236

(51) Int. Cl. G01S 7/48; G01S 7/481; G01S 17/89; G01S 17/931; G01S 17/933; G06V 10/143; G06V 10/147; G06V 10/764; G06V 10/80; G06V 20/54; G06V 20/60

(52) U.S. Cl. CPC G01S 7/4802; G01S 7/4814; G01S 7/4816; G01S 17/89; G01S 17/931; G01S 17/933; G06V 10/143; G06V 10/147; G06V 10/764; G06V 10/803; G06V 20/54; G06V 20/60

(57) ABSTRACT

A system provided includes an RGB image sensor; a near infrared (NIR) image sensor, an NIR pulse laser, and a processor performing steps of capturing one or more RGB images of a field of view (FOV) and multiple NIR images from a plurality of NIR exposures of reflections of NIR pulses from the same FOV. The system further provides generating a multi-mode image, wherein each pixel of the multi-mode image has a set of values derived from corresponding pixels in multiple images, where the multiple images include at least one of the one or more RGB images, at least one of the multiple NIR non pulse images, and an NIR pulse-only image, a retro-reflector image, a distance image, and a velocity image.

### FIELD OF THE INVENTION

The present invention generally relates to the field of automated object detection and recognition.

### BACKGROUND

Real-time object detection and recognition is required for a range of applications, such as advanced driver-assistance systems (ADAS), as well as for security applications such as perimeter protection and drone recognition. However, despite advances in the field, accurate object detection may fail due to factors such as poor environmental conditions, such as low lighting and visibility, or similarity of the target object to the background (for example, when an object is camouflaged). A practical ADAS typically requires data from multiple sensors that provide complementary information, in order to improve reliability and to reduce the FAR (False Alarm Ratio) in detection, recognition and identification of objects in the field of view. (Hereinbelow, the processes of detection, identification, and recognition are collectively referred to simply as recognition processes.)

Given the growing use of unmanned aerial vehicles (UAVs), i.e., drones, for implementing harmful purposes, such as military or terrorist actions of assault or espionage, UAVs represent a potential threat, especially to sensitive facilities and to aircraft in flight. Airports in particular are sensitive targets of attack that need early warning of potential drone attacks. Detection of drones in flight may also be applied to the prevention of drug and weapons smuggling.

Real-time object detection may be performed by visual means (e.g., cameras), and/or by audio means (e.g., microphones), and/or by electromagnetic means (e.g., radar).

Each approach has advantages and disadvantages, but all solutions currently available in the market belong to at least one of these categories, and each suffer from problems. In addition, detection of UAV's may rely on detecting communications of the UAV system. However, this solution is not effective when the UAV operates in “wireless silence” (i.e., does not transmit). Radar-based solutions are similarly problematic, given the small cross-sectional area of drones, reducing the range at which they can be detected and leading to false alarms, especially in a “noisy” environment, such as an area of obstructions such as of trees, buildings, birds in flight, etc.

In order to increase the probability of object detection, reducing false alarms and improving performance, additional technological solutions are needed beyond those currently used.

### SUMMARY

The invention disclosed herein includes a system and method for object recognition. The system includes: a red, green, blue (RGB) image sensor (configured to generate RGB images including a field of view); a co-located, near infrared (NIR) image sensor (configured to generate NIR images including the field of view); a co-located NIR laser configured to emit NIR pulses towards the FOV; and a processor having associated non-transient memory with instructions that when executed by the processor perform steps of a process to achieve image recognition. These steps of the process include: receiving one or more RGB images from the RGB image sensor; receiving multiple NIR pulse-enhanced image and multiple NIR non-pulse images from the NIR image sensor and determining multiple respective NIR pulse-only images. The multiple NIR pulse-enhanced images include reflections of NIR pulses from objects in the FOV, NIR non-pulse images are taken without NIR pulses.

The process may further include: determining, from the multiple NIR pulse-only images, multiple respective retro-reflector images, each pixel of the retro-reflector image indicating whether a corresponding point in the FOV is part of a retro-reflector; determining, from the multiple NIR pulse-only images, a distance image, each pixel of the distance image indicating a distance range from the NIR image sensor to a point corresponding to the pixel in the FOV; determining, from the multiple NIR retro-reflector images, a velocity image, each pixel of the velocity image indicating a velocity of a retro-reflector at a point corresponding to the pixel in the FOV; generating a multi-mode image, wherein each pixel of the multi-mode image has a set of values derived from corresponding pixels in multiple images, where the multiple images include at least one of the one or more RGB images, at least one of the multiple NIR non-pulse images, at least one of the multiple NIR pulse-only images, at least one of the retro-reflector images, the distance image, the velocity image, and a map of x, y coordinates of the FOV, wherein each pixel of the multi-mode image corresponds to one of the x, y coordinates. The process may further include a step of subsequently applying the multi-mode image to a trained ML model to recognize objects in the multi-mode image.

The process may also include comparing an intensity metric of at least one of the NIR pulse-only images to a preset threshold, determining that the intensity metric is insufficient, capturing a new NIR image (i.e., pulse-enhanced image) including a greater number of NIR pulses, and repeating generating of the additional images of the multi-mode image.

The process may also include generating multiple multi-mode images and applying the multiple multi-mode images to an object recognition machine learning (ML) model to train a ML model to recognize objects in multi-mode images.

The ML model may also correlate objects with surface types, which may be categorized by reflectiveness. Reflectiveness may be determined as being proportional to a pixel value of the at least one of the multiple NIR pulse-only images.

The ML model may provide object recognition for applications including an advanced driver-assistance system (ADAS), an autonomous driving system, an anti-collision system, a train system, and a drone detection system.

The ML model may be trained to detect retro-reflecting objects including drones, observation systems, video cameras, optical lenses, and binoculars.

The NIR images may be generated by time-gated capture of the FOV. For each pixel of the distance image, bounds of the distance range are proportional to start and stop times of a time-gated capture of the FOV.

Brightness of pixels of the NIR pulse-only images may be proportional to an amount of return laser pulse captured from an object and to a distance of the object.

For each object, according to a positional and size difference in two or more respective NIR images, an object velocity value of the object may be determined.

It is to be understood that the RGB and near infrared (NIR) image sensors may be separate image sensors or a merged sensor including both RGB and NIR sensitive pixel elements in a single chip. The FOV may be a mutual subset of total fields of view of the RGB and NIR image sensors.

### BRIEF DESCRIPTION OF DRAWINGS

For a better understanding of implementation of the invention and to show how the same may be carried into effect, reference will now be made, by way of example, to the accompanying drawings. Structural details of the invention are shown to provide a fundamental understanding of the invention, the description, taken with the drawings, making apparent to those skilled in the art how the several forms of the invention may be embodied in practice. In the figures:

FIG. 1 is a schematic diagram of a system for generating data sets for object recognition, in accordance with an embodiment of the present invention;

FIGS. 2A and 2B are schematic diagrams of elements of the system for generating data sets for object recognition, in accordance with an embodiment of the present invention;

FIG. 3 is a schematic diagram of a process of correlating pixels with coordinates of a field of view (FOV) of image sensors of the system, in accordance with an embodiment of the present invention;

FIGS. 4A and 4B are schematic timing diagrams of a pulse cycle during operation of the system, in accordance with an embodiment of the present invention;

FIGS. 5A-5C are images showing a “pulse-only” imaging process implemented by the system, in accordance with an embodiment of the present invention;

FIGS. 6A and 6B are schematic timing diagrams of gated ranging performed during operation of the system, in accordance with an embodiment of the present invention;

FIGS. 7A-7D are a set of images showing image results of gated ranging by the system, in accordance with an embodiment of the present invention; and

FIG. 8 is a flow diagram of steps of operation of the system, in accordance with an embodiment of the present invention.

### DETAILED DESCRIPTION

It is to be understood that the invention is not necessarily limited in its application to the details of construction and the arrangement of the components and/or methods set forth in the following description and/or illustrated in the drawings.

The present invention includes a system for generating data sets for object recognition, in accordance with an embodiment of the present invention. Applications of the object recognition include applications such as an autonomous driving system, an anti-collision system, a railroad system, or a drone detection system. Object detection, such as drone detection, is based on detecting retro reflections from surfaces and objects that act as retro-reflectors, including cameras, or other observation devices mounted on a drone. The system calculates one or more of the following parameters: the location of the object, range to the object, and flight speed (in the case of flying objects, such as drones).

The main goals of object detection systems, such as for ADAS or drone detection, are to achieve maximum readiness and precision in the detection, identification and recognition of the objects in the field of view (FOV) of image sensors. To reach a high level of precision it is necessary to obtain data from sensors that complement each other, thus providing multi-modal data. Data provided by the present invention enhance less robust, single mode type of data acquisition, providing a robust solution particularly in low visibility situations.

The solution disclosed herein exploits the presence, in an image sensor FOV, of “retro-reflectors” that reflect a high level of laser light. These “retro-reflectors” exist on objects such as electro-optical devices and imaging systems, including surveillance video cameras, car cameras (such as: dash cam, lidar, or driving cameras), drone cameras, observation optic systems (such as: binoculars), cat eyes on the road, headlights of the vehicle, vehicle license plates, road signs, etc. The present invention includes a fusion of sensor data whereby data from different modes (also referred to herein as “dimensions”) is correlated at the level of image pixels to improve training and subsequent application of machine learning recognition. Reflectance value for each object might also indicate the type of surface of the object, where every pixel is brightness/value coded to indicate the respective type of object, such as; asphalt, road signs, rubber, chrome, auto paint, cotton clothing on a person, or cement and more. Retro-reflection is detected from objects such as: video cameras, various observation devices, car headlights, and vehicle license plates. An algorithm applied by the system can filter the data or make decisions, for example: differentiating between a drone flying in the sky with a video camera and a bird, because the bird does not have an optics or video camera and does not have retro-reflection, but the video camera that is mounted on the drone has the retro-reflection. The algorithm also distinguishes between a vehicle and another object by detecting the headlights and license plate of the vehicle.

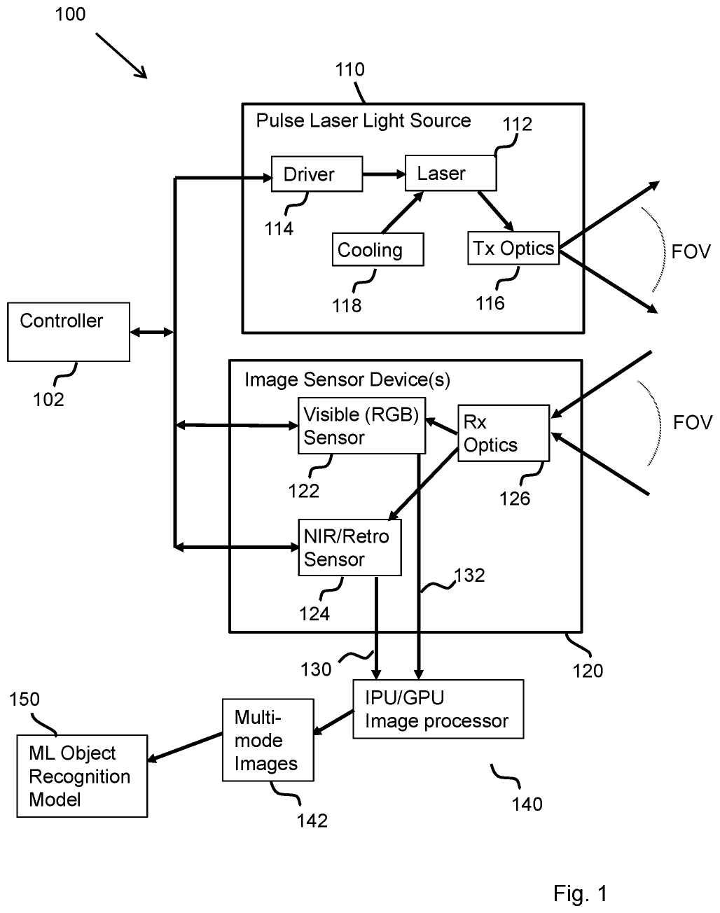

FIG. 1 is a schematic diagrams of elements of a system 100 for generating data sets for object recognition. The system 100 includes a pulse laser light source 110, which includes a near infrared (NIR) laser 112. Associated components of the NIR laser 112 may include a laser driver 114, which controls laser pulsing, according to signals from the controller 102, as well as transmission optics 116, and typically a cooling mechanism 118 to cool the laser. The transmission optics spread the generated laser over an area referred to herein as a field of view (FOV).

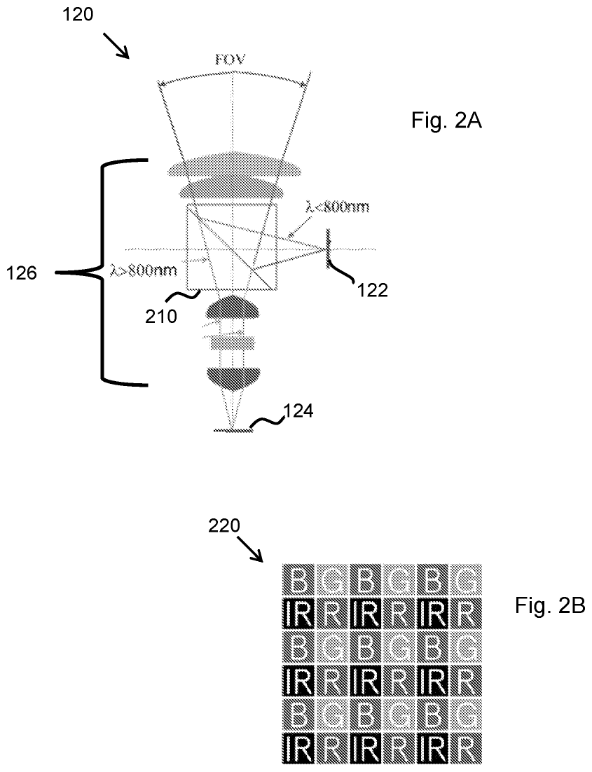

System 100 also includes an image sensor device 120 (also referred to hereinbelow as an NIR/RGB camera) that includes a visible light (e.g., a red, green, blue, i.e., RGB light) image sensor 122 and a near infrared (NIR) image sensor 124. The image sensors are co-located, meaning that their fields of view (FOV) at least partially overlap, such that some or all of their respective FOVs are common (i.e., a shared FOV). Moreover, at least part of the common FOV also covers the FOV of the transmitted laser pulse described above. Typically, the two image sensors capture images of a common FOV through the same receiver (Rx) optics 126, as described with respect to FIG. 2A, described below. It is to be understood that system 100 may also employ a single optics system for both transmission and for reception. Regardless of whether the same optics system is used, the pulse laser light source 110, the RGB light sensor 122 and the NIR sensor 124 are all typically co-located meaning located in a single unit or in co-joined units, so as to send and receive light from the FOV, from approximately the same perspective.

NIR images 130 captured by the NIR image sensor and RGB images 132 captured by the RGB image sensors are transmitted from the image sensors to a processor 140, which is configured as an image processing unit (IPU), and which may include a graphics processing unit (GPU). As described further hereinbelow, NIR images may include two types of images, pulse-enhanced NIR images that are taken when the laser pulses are operating (which may utilize multiple exposures during multiple respective laser pulses), and NIR non-pulse images (also referred to as NIR background images), taken when no laser pulses are employed, such that there are no reflections from retro-reflectors in the FOV.

The processor 140 generates multiple “layers” of image data 142 associated with the common FOV of the sensors, as described further hereinbelow. The layers of image data are also referred to herein as “multi-mode images” or as a multi-mode dataset. Typically, the multi-mode images are then transmitted to a machine learning (ML) model 150 also referred to herein as an object recognition model 150, which may be trained by similar image datasets to detect and to identify objects in the FOV.

FIG. 2A shows an exemplary implementation of the image sensor device 120 incorporating the RGB image sensor 122, the NIR image sensor 124, and the receiver optics 126. The receiver optics may include a beam splitter 210, which directs electromagnetic radiation that is in the NIR range (as well as longer wavelengths, i.e., wavelengths greater than 800 nm) to the NIR image sensor 124. The beam splitter 210 similarly directs light in the visible range and shorter wavelengths (less than 800 nm) to the RGB image sensor.

Alternatively, a device having optics similar to those of a standard camera may be employed with a merged RGB/NIR sensor 220, shown in FIG. 2B, which includes both standard visible light RGB pixel elements, as well as infrared-sensitive IR pixel elements.

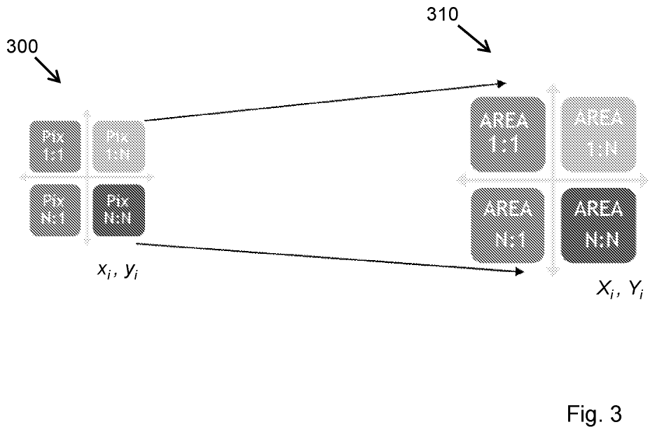

FIG. 3 is a schematic diagram showing a correlation between pixel elements 300 of the RGB and NIR image sensors and respectively larger points 310 of the FOV, also referred to as areas. By sharing common receiver optics, the RGB and NIR image sensors have a common FOV. Coordinates of objects in the FOV are identified by their distance (“Z”) from the image sensor device, as described below, as well as by their position in an X, Y coordinate plane. The Xᵢ, Yᵢ coordinates of objects correspond to xᵢ, yᵢ pixel elements of a given image captured by the RGB and NIR image sensors.

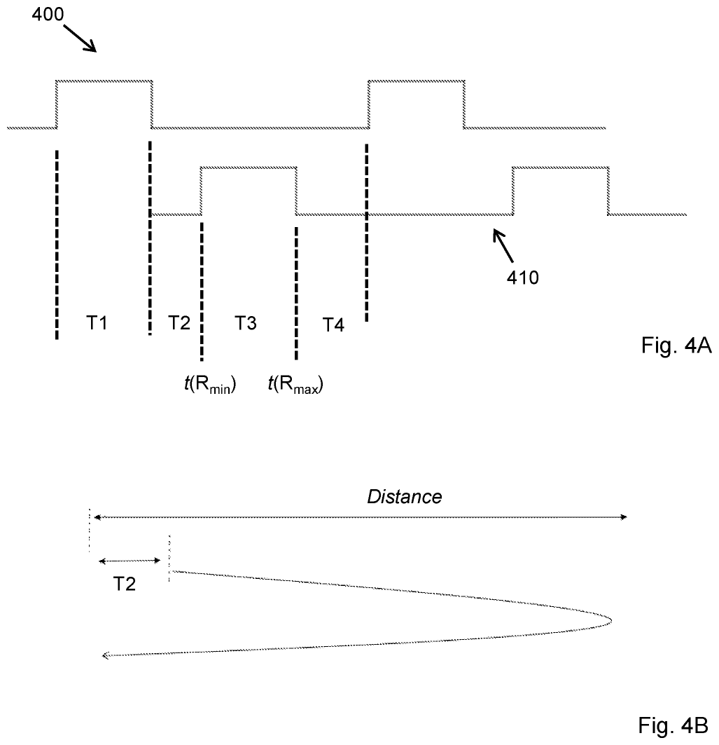

FIGS. 4A and 4B are schematic timing diagrams of a “pulse cycle” during NIR image capture. The NIR image sensor 124 is typically set by the controller 102 to receive multiple exposures before the total sum of exposures is transmitted as an image. For example, the NIR image sensor may be a sensor designed with a multi-exposure trigger, as described in the IMX530 Application Note from Sony Semiconductor Solutions Corp., 2019. Alternatively or additionally, the image sensor device 120 may have a mechanical or optical shutter that opens and closes multiple times, providing multiple exposures that the NIR sensor 124 merges into a single captured image (also referred to herein as a “frame”). Examples of an optical shutter include high speed gated image intensifiers available from Hamamatsu Photonics, which open or close an electronic shutter by varying a voltage potential between a photocathode and a microchannel plate (MCP) that multiplies electrons.

A single exposure cycle of the NIR sensor has four stages T1-T4. A laser pulse of a pulse signal 400 is emitted during stage T1, that is, the pulse “active time” is the length of time indicated as T1. Stage T2 is the subsequent delay stage, having a length of time indicated as T2, the “exposure start delay time.” A time indicated as t(Rₘᵢₙ) indicates the start of a third stage of the cycle, T3, which continues until a time indicated as t(Rₘₐₓ). During stage T3, an exposure trigger signal 410 is triggered, causing the NIR image sensor to be exposed to the FOV. Depending on the distance between the image sensor device and the objects in the FOV, the exposure may include at least a portion of reflections of the laser pulse emitted during T1.

The last stage of the exposure cycle is a pulse start delay time, T4. Subsequently, a new cycle starts with a new laser pulse of duration T1.

The T1, T2, T3, T4 values are calculated by the following equations:

$$T 2 = 2 * R min / C ( where C = 3 * 10 \hat{} 8 m / sec and R min is the minimum range for object detection ) .$$

$$T 1 = T 3 = 2 * R max / C - 2 * R min / C ( where R max is the maximum range that the object can be located ) .$$

$$T 4 = Laser ON time + Camera OFF time .$$

By default, the system may be configured for a single exposure cycle, but the number of pulses (and corresponding exposures) may be increased until a sufficient level of brightness is achieved for object recognition. As described below, the system may also be configured with a threshold level of exposure brightness, and the number of exposure cycles, N, is increased until the threshold is reached. FIG. 4B shows the T2 delay with respect to the distance travelled by an NIR laser pulse. The T2 delay period serves several purposes, including reducing the capture of “no-pulse” background light, reducing atmospheric reflection of light, and setting the start of ranging time t(Rₘᵢₙ), which is used for determining object distances, as described further below.

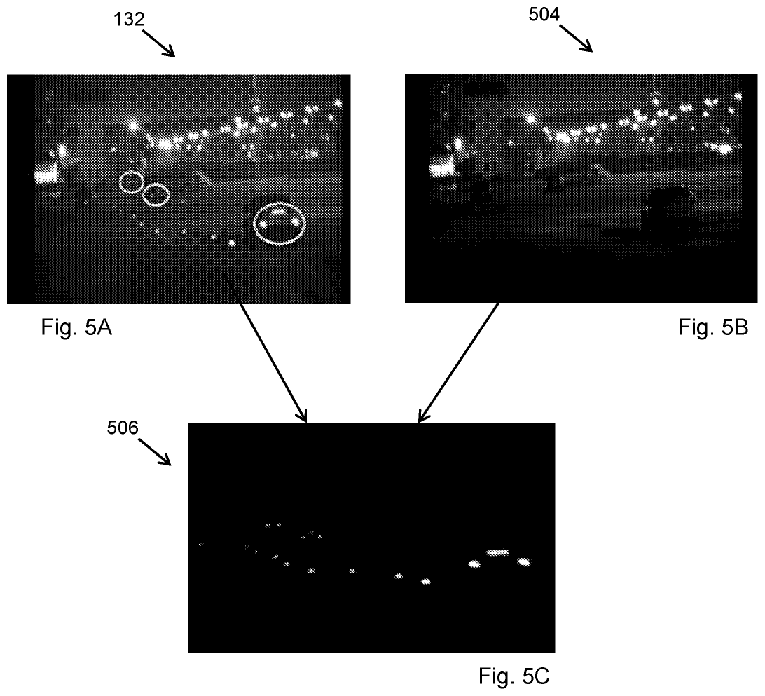

FIGS. 5A-5C are images showing the generation of “pulse-only” images by the system 100.

Shown in FIG. 5A is an example of a pulse-enhanced NIR image 502, that is, an image captured by the NIR image sensor during an exposure cycle described above. Such an image is also referred to herein as a NIR image. Bright dots in the NIR image indicate reflections of the laser pulse from particular bright reflectors. Such reflectors are also referred to herein as “retro-reflectors,” as they return most of the laser energy received towards the source, that is, the NIR laser, which is co-located with the image sensor device.

The same scene of the NIR image (i.e., the FOV) is also captured in at least one NIR non-pulse image 504, that is, an NIR image without the laser pulse, an example of which is shown in FIG. 5B. The result of subtracting the non-pulse NIR image from the exposure cycle NIR image is a “pulse-only” image 506, an example of which is shown in FIG. 5C.

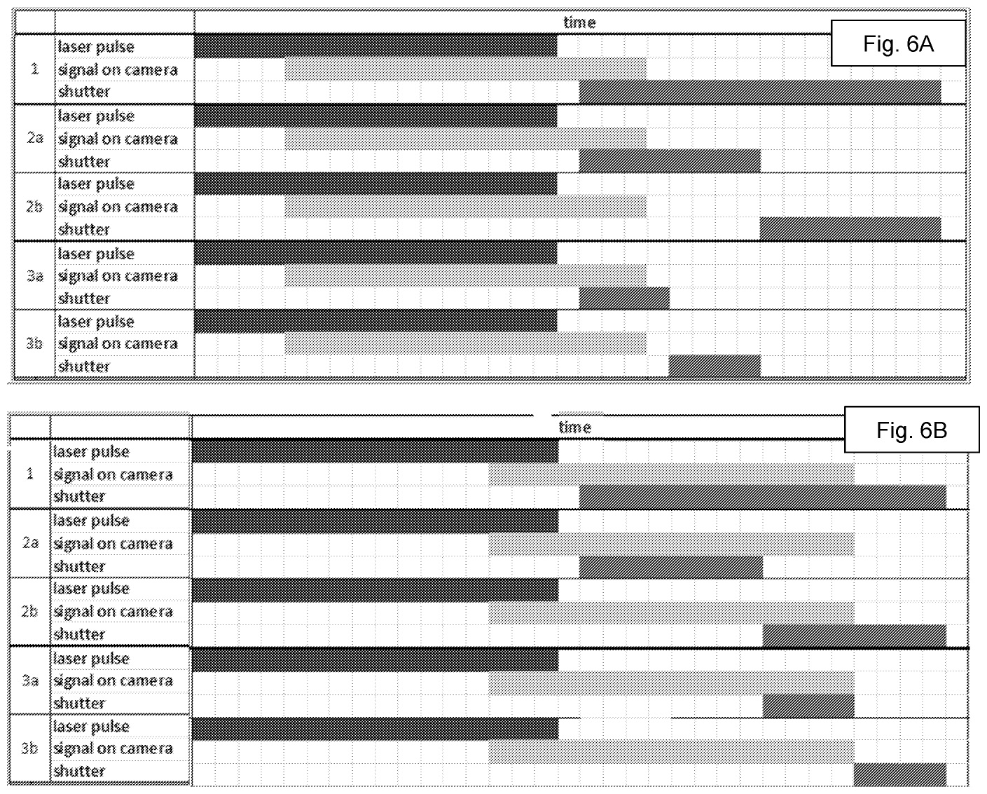

FIGS. 6A and 6B are schematic timing diagrams of “gated ranging,” performed by the system to determine distances of objects in the FOV. Typically, the controller is configured to control the laser and NIR sensor to synchronize laser pulses and NIR sensor exposures. Distance ranges are determined by varying the t(Rₘᵢₙ) and t(Rₘₐₓ) of the T3 exposure period to capture some or all of a reflected laser pulse. In the diagram of FIG. 6A, a laser pulse returns relatively quickly from a given object in the FOV to a given pixel of the NIR image sensor (the laser “signal on camera” being offset from the emitted laser pulse by only a small time delay). Five different exemplary types of exposure are indicated as 1, 2a, 2b, 3a, and 3b (indicated as the “shutter” row). Type 1 exposure starts after the end of the laser pulse, at which point only a small portion of the returning laser pulse is captured. Consequently, relative to the full power of the laser pulse, the brightness of the captured pulse is significantly diminished. Shortening the exposure period, as shown for exposure type 2a, increases the proportional amount of return laser pulse captured, indicating that most of the pulse is before the exposure rather than afterwards. For exposure type 3b, there is no overlap between the reflected laser pulse and the exposure, indicating that the end of the pulse comes before the beginning of the exposure. The gating provides a means of determining a distance range based on pixel brightness of reflected NIR laser images, rather than a time-of-flight calculation for each pixel, a process that would require much higher processing speeds.

FIG. 6b shows the same five different exemplary types of exposure (1, 2a, 2b, 3a, and 3b) for a pixel receiving a laser pulse from an object that is farther from the image sensor device. The laser “signal on the camera” is offset from the emitted laser pulse by a longer gap than for the scenario shown in FIG. 6A.

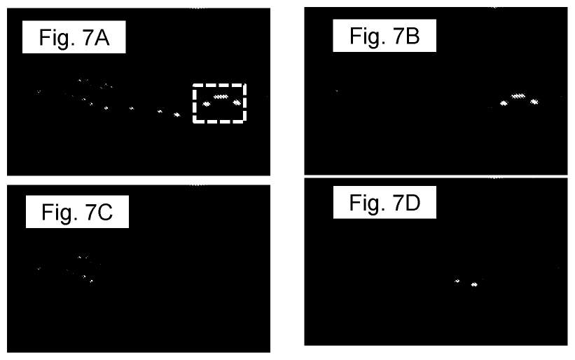

FIGS. 7A-7D are a set of images showing image results of gated ranging by the system. FIG. 7A shows a relatively long exposure image, in which are shown multiple points of reflected laser pulses, i.e., reflected light from retro-reflecting type objects in a “pulse-only” image, which is generated as described above. These “retro-reflector” types of objects may include electro-optical devices, cat eyes on the road, headlights of vehicles, car cameras, cameras of drones, vehicle license plates, road signs, etc. FIGS. 7B-7D show that only certain reflected points are captured in shorter exposures with different exposure start times. The distance range of each set of points is determined by correlating the time of each gated exposure with the range of distance travelled by the reflected laser pulse. The distance range of each pixel is inversely related to the brightness of the corresponding pixel in the at least one of the multiple NIR pulse-only images. Bounds of the distance range are proportional to start and stop times of the time-gated capture of the FOV. The brightness of reflections of the NIR laser pulses is directly related to a percent of pulse energy captured, that is, when less than an entire pulse is captured, a tighter range bound of an object can be determined.

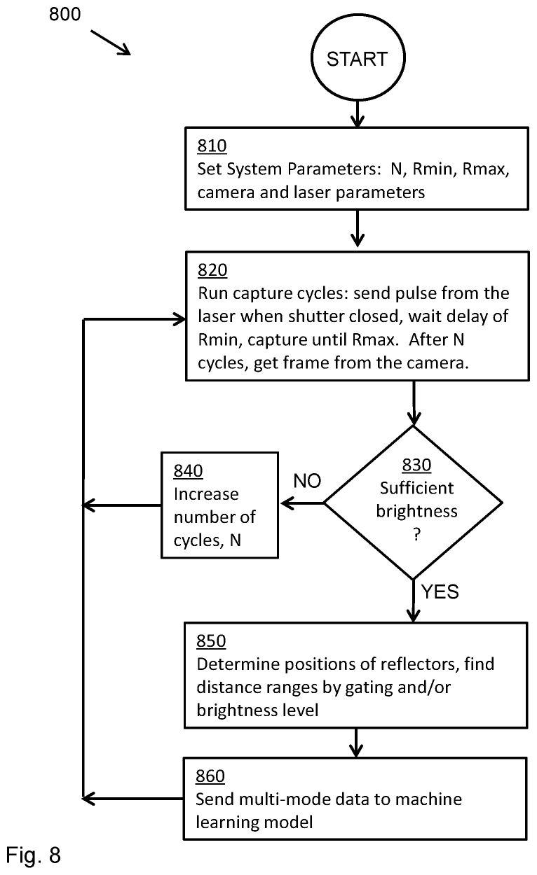

FIG. 8 is a flow diagram of a process 800 implemented by the one or more processors of system 100, performing the functions of controller 102 and of the IPU/GPU 140. At a first step 810, parameters of the pulse laser and image sensors are set, including a default number N of image captures (“exposure cycles”) captured in a single generated image, with timing parameters Rₘᵢₙ and Rₘₐₓ, the offsets of the image capture with respect to the NIR laser pulses.

At a subsequent step 820, image exposure/capture cycles are performed as described above. For each laser pulse emitted, a delay of time t(Rₘᵢₙ) is added, and then an image is captured until time t(Rₘₐₓ). After N cycles, an image frame from the image sensor device is acquired, together with a corresponding RGB image and a corresponding NIR non-pulse image of a common FOV. The image frame may include “gated” images that correspond to object distances, as described above.

At a step 830, brightness of the captured NIR image from N cycles is compared with a preset threshold. If the brightness is not sufficient, the number of exposure cycles, N, may be increased at step 840, after which step 820 repeated.

If the brightness is sufficient, then, at a step 850, the NIR pulse and non-pulse images are processed, as described above to determine pulse-only images (i.e., images of retro-reflecting objects). From one or more “gated” images, a distance image may then be generated, each pixel of the distance image indicating a distance range from the NIR laser to a point corresponding to the pixel in the FOV. From the multiple NIR pulse-only images, multiple respective retro-reflector images may also be generated by the processor, each pixel of the retro-reflector images indicating whether a corresponding point in the FOV is part of a retro-reflector.

From the multiple NIR retro-reflector images, movement of retro-reflector points may be determined and a velocity image may be generated, each pixel of the velocity image indicating a velocity of a retro-reflector at a point corresponding to the pixel in the FOV. Note that in order to create the “velocity” image, multiple NIR pulse-enhanced and non-pulse images must be taken.

At a step 860, the processor then sends (i.e., “applies) the resulting “multi-mode” image to the ML model 150 (which may execute on the processor or on a separate processor). The ML model is trained to recognize objects in the multi-mode image (described above with respect to FIG. 1). Each pixel of the multi-mode image has a set of values derived from corresponding pixels in multiple images, where the multiple images include the following: at least one of the one or more RGB images; at least one of the multiple NIR non pulse images; at least one of the multiple NIR pulse-only images; the retro-reflector image; the distance image; the velocity image; and a map of x, y coordinates of the FOV. Each pixel of the multi-mode image corresponds to one of the x, y coordinates of the FOV.

The ML model may be trained to also determine a potential threat (or threat level) of identified objects and to provide an alert if a potential threat is identified. If no threat is identified, the multi-mode image, or one or more individuals layers of the multi-mode image, may be set by the processor as a “reference image.” Subsequently, as new multi-mode images are acquired, they may be compared with the reference image to determine whether or not there are changes. If there are no changes, processing by the ML model is not necessary.

The system and computer-implemented methods of the present invention can be implemented according to instructions stored in computer-readable storage media other than that described herein, as will become apparent to those having skill in the art. Any reference to systems and computer-readable storage media with respect to the following computer-implemented methods is provided for explanatory purposes, and is not intended to limit any of such systems or methods with regard to the computer-implemented methods. Processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The flowcharts and block diagrams in the figures illustrate the architecture, functionality, and operation of possible implementations of systems. In this regard, each block in the flowchart or block diagrams may represent a module, segment, or portion of code, which comprises one or more executable instructions for implementing the specified logical function(s). It should also be noted that the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that in the above description, the word “exemplary” as used herein means “serving as an example, instance or illustration,” and is not necessarily to be construed as preferred or advantageous over other methods of implementing the invention. Moreover, features described above as being “alternatives” may be combined in a single implementation of the invention. Conversely, various features of the invention, which are, for brevity, described in the context of a single embodiment, may also be provided separately or in any suitable sub-combination or as suitable in any other described embodiment of the invention. Elements or features of the invention are not to be considered essential unless the invention is inoperative without those elements or features.

The following table includes definitions of the numeric indicators used in the figures:

| Numeric | |
|---|---|
| Indicator | Element |
| 100 | image data generation system |
| 110 | pulse laser light source |
| 112 | NIR laser |
| 114 | laser driver |
| 116 | transmission optics |
| 120 | image sensor device |
| 122 | RGB image sensor |
| 124 | NIR image sensor |
| 126 | receiver optics |
| 130 | RGB Images |
| 132 | NIR images |
| 140 | processor |
| 142 | image data |
| 150 | ML object recognition model |
| 210 | sensor device beam splitter |
| 220 | merged RGB/NIR sensor |
| 400 | laser pulse signal |
| 410 | exposure trigger signal |
| 504 | NIR non-pulse image |
| 810-860 | process flowchart steps |

1. A system (100) for object recognition, the system comprising:
a red, green, blue (RGB) image sensor (122) configured to generate RGB images of a field of view (FOV);
a co-located, near infrared (NIR) image sensor (124) configured to capture NIR images of the FOV;
a co-located NIR laser (110) configured to emit NIR pulses towards the FOV; and
a processor (140) having associated non-transient memory with instructions that when executed by the processor perform a process comprising steps of:
a) receiving one or more RGB images from the RGB image sensor;
b) receiving multiple NIR non-pulse images from the NIR image sensor;
c) receiving multiple NIR pulse-enhanced images, each including reflections of NIR laser pulses from retro-reflectors in the FOV, wherein each NIR pulse-enhanced image is generated from multiple NIR image sensor exposures, wherein the number of NIR image sensor exposures is N, wherein each NIR image sensor exposure is synchronized with a respective laser pulse, wherein each synchronized laser pulse of each NIR image sensor exposure has a duration of 2*(Rₘₐₓ−Rₘᵢₙ)/C, wherein each NIR image sensor exposure has a duration equal to the laser pulse and offset from the laser pulse by 2*Rₘᵢₙ/C, where C is the speed of light, Rₘᵢₙ is a minimum range for object detection, and Rₘₐₓ is a maximum range for object detection;
d) determining, from the multiple NIR non-pulse images and the multiple NIR pulse-enhanced images, multiple respective NIR pulse-only images, comparing a brightness of the NIR pulse-only images with a preset threshold, and, when the brightness is insufficient, increasing the number N of NIR image sensor exposures and repeating steps a-d;
e) determining, from the multiple NIR pulse-only images, multiple respective retro-reflector images, each pixel of each retro-reflector image indicating whether a corresponding point in the FOV is part of a retro-reflector;
f) determining a distance image, each pixel of the distance image indicating a distance range from the NIR image sensor to a point corresponding to the pixel in the FOV;
g) determining, from the multiple NIR retro-reflector images, a velocity image, each pixel of the velocity image indicating a velocity of a retro-reflector at a point corresponding to the pixel in the FOV;
h) generating a multi-mode image, wherein each pixel of the multi-mode image has a set of values derived from corresponding pixels in multiple images, where the multiple images include at least one of the one or more RGB images, at least one of the multiple NIR non-pulse images, at least one of the multiple NIR pulse-only images, at least one of the retro-reflector images, as well as the distance image, the velocity image, and a map of x, y coordinates of the FOV, wherein each pixel of the multi-mode image corresponds to one of the x, y coordinates; and
i) applying the multi-mode image to a trained ML model to recognize objects in the multi-mode image.

2. The system of claim 1, wherein the process further comprises a step of generating multiple multi-mode images and applying the multiple multi-mode images to an untrained object recognition machine learning (ML) model to generate the trained ML model to recognize objects in multi-mode images.

3. The system of claim 2, wherein the ML model correlates objects with surface types, wherein surface types are categorized by reflectiveness, and wherein reflectiveness is determined as being proportional to a pixel value of the at least one of the multiple NIR pulse-only images.

4. The system of claim 2, wherein the ML model provides object recognition for one of an advanced driver-assistance system (ADAS), an autonomous driving system, an anti-collision system, a train system, and a drone detection system.

5. The system of claim 2, wherein the ML model is trained to detect retro-reflecting objects including drones, observation systems, video cameras, optical lenses, and binoculars.

6. The system of claim 1, wherein brightness of pixels of the NIR pulse-only images is proportional to an amount of return laser pulse captured from an object and to a distance of the object.

7. The system of claim 1, wherein the RGB and NIR sensors are separate image sensors.

8. The system of claim 1, wherein the RGB and red (NIR) image sensors are a merged sensor including both RGB and NIR sensitive pixel elements in a single chip.

9. The system of claim 1, wherein the FOV is a mutual subset of total fields of view of the RGB and NIR image sensors.

10. A method of object recognition, implemented by a processor (140) having associated non-transient memory with instructions that when executed by the processor perform steps of:
a) receiving one or more RGB images from a red, green, blue (RGB) image sensor (122) configured to generate RGB images of a field of view (FOV);
b) receiving multiple NIR non-pulse images from a co-located, near infrared (NIR) image sensor (124) configured to capture NIR images of the FOV;
c) receiving multiple NIR pulse-enhanced images, each including reflections of NIR laser pulses from retro-reflectors in the FOV, wherein the laser pulses are generated by a co-located NIR laser (110) configured to emit NIR pulses towards the FOV, wherein each NIR pulse-enhanced image is generated from multiple NIR image sensor exposures, wherein the number of NIR image sensor exposures is N, wherein each NIR image sensor exposure is synchronized with a respective laser pulse, wherein each synchronized laser pulse of each NIR image sensor exposure has a duration of 2*(Rₘₐₓ−Rₘᵢₙ)/C, wherein each NIR image sensor exposure has a duration equal to the laser pulse and offset from the laser pulse by 2*Rₘᵢₙ/C, where C is the speed of light, Rₘᵢₙ is a minimum range for object detection, and Rₘₐₓ is a maximum range for object detection;
d) determining, from the multiple NIR non-pulse images and the multiple NIR pulse-enhanced images, multiple respective NIR pulse-only images comparing a brightness of the NIR pulse-only images with a preset threshold, and, until the brightness is sufficient, increasing the number N of NIR image sensor exposures and repeating steps a-d;
e) determining, from the multiple NIR pulse-only images, multiple respective retro-reflector images, each pixel of each retro-reflector image indicating whether a corresponding point in the FOV is part of a retro-reflector;
f) determining, from the multiple NIR pulse-only images, a distance image, each pixel of the distance image indicating a distance range from the NIR image sensor to a point corresponding to the pixel in the FOV;
g) determining, from the multiple NIR retro-reflector images, a velocity image, each pixel of the velocity image indicating a velocity of a retro-reflector at a point corresponding to the pixel in the FOV;
h) generating a multi-mode image, wherein each pixel of the multi-mode image has a set of values derived from corresponding pixels in multiple images, where the multiple images include at least one of the one or more RGB images, at least one of the multiple NIR non-pulse images, at least one of the multiple NIR pulse-only images, the retro-reflector image, the distance image, the velocity image, and a map of x, y coordinates of the FOV, wherein each pixel of the multi-mode image corresponds to one of the x, y coordinates; and
i) applying the multi-mode image to a trained ML model to recognize objects in the multi-mode image.
